(19) United States
(12) Patent Application Publication
(10) Pub. No.: US 2008/0160485 A1
(43) Pub. Date: Jul. 3, 2008

(54) Method and apparatus for selecting translucent dental materials

(76) Inventor: C. Alex Touchstone, Clover, SC (US)

Correspondence Address: CHRISTIE, PARKER & HALE, LLP, PO BOX 7068, PASADENA, CA, 91109-7068, US

(21) Appl. No.: 11/982,556

(22) Filed: Oct. 31, 2007

Related U.S. Application Data
(60) Provisional application No. 60/855,439, filed on Oct. 31, 2006.

(51) Int. Cl. A61C 19/04

(52) U.S. Cl. 433/215

(57) ABSTRACT

The present invention relates to a shade or color determination apparatus and method for dental restorations where translucent materials are used that account for the influence of underlying tooth structure and each successive layer on the final shade of the dental restorations when an opaque layer of dental material is not used in the fabrication of the dental restoration.

### CROSS-REFERENCE TO RELATED APPLICATION(S)

This application claims priority under 35 U.S.C. § 119(e) to U.S. Provisional Application Ser. No. 60/855,439, filed Oct. 31, 2006, the entire contents of which are incorporated by reference herein.

### FIELD OF INVENTION

The present invention is generally directed toward the field of dental reconstructions. More particularly, the present invention is directed toward a method and apparatus for selection of a dental restoration that uses translucent material(s) with improved matching with the color and appearance of an individual's teeth.

### BACKGROUND OF INVENTION

Commercially available shade guides have a plurality of color groups, wherein each group is representative of a tooth with a certain brightness, saturation and/or hue and, thus, is assigned a certain shade. Each individual shade in a shade guide is termed a shade tab and is typically fabricated to resemble the shape of an upper incisor tooth with a material structure of one to as many as five or more layers of material.

A shade guide is limited in its effectiveness as a shade determination device. First, commercial shade guides have a limited number of shade tabs. Moreover, the user's ability to discern one shade from another is often compromised by the user's inability to discern small color differences due to eye strain, non-standard lighting conditions or by problems with the user's anatomy related to color discrimination.

Additional problems arise in achieving an accurate shade match using a commercial shade guide due to differences in the physical and, thus, light refractive properties of the materials used to manufacture the shade guides themselves versus the materials used to fabricate dental restorations.

While there exists prior art whose aim is to overcome many of the limitations inherent in the use of commercial shade guides, other methods fail to address the influence of the color of the underlying tooth structure on the final shade of a dental restoration when translucent dental materials are used without an opaque layer to mask out the internal structure's influence.

Until recently, the use of an opaque layer in the fabrication of dental restorations was the norm. However, with the introduction and increasing use of more durable translucent dental ceramics in the fabrication of dental restorations, an opaque core material is often no longer employed. Because these ceramic restorations have no opaque core, the final color of the restoration is influenced by the color, or shade, of the prepped tooth that underlies and supports the restoration itself. Moreover, when a dental restoration comprises multiple layers of translucent material, the final shade of the restoration results from the composite effect of the optical properties of each material layer and that of the prepped tooth itself. It is therefore desirable to have a method and system that consider the influence of the prepped tooth and the composite effect of optical properties of each material layer on the final shade of the restoration where translucent materials are used.

### BRIEF SUMMARY OF THE INVENTION

An object of the present invention is therefore to provide a dental material(s) and/or shade selection apparatus that will measure, predict and accurately account for influence of an underlying prepared tooth on a final shade of a dental restoration when layer(s) of translucent dental materials are used without an opaque masking layer thereby significantly improving shade matching in such circumstances.

This object is achieved in accordance with an apparatus and method of the present invention. The present invention is directed toward a method and system of producing a dental restoration body that includes construction of a model of a dental restoration body for application to a basic dental structure such as a prepared tooth. The dental restoration body may be any type of dental restoration such as an inlay, an onlay, a crown or a veneer. The restoration body is made of one or more translucent dental materials using one or more of several methods, known to individuals skilled in the art, such as pressing, casting, layering, 3D printing, and/or rapid prototyping. In accordance with the method, reference data concerning relevant optical properties of different translucent dental materials are provided and stored and a dependency between relevant optical properties of the basic dental structure and the translucent dental materials is applied to the stored data based on various user-input parameters, where different models using different translucent dental materials are generated, from which one or more best shade match models are selected. The user-input parameters include target value(s) for desired optical properties of the dental restoration body to be produced, a thickness of the restoration body and a shade of the prepped tooth. The dependency may be applied as a functional dependency, such as in the embodiment described above, or it may be applied empirically in an alternative embodiment with look-up tables of optical properties of a variety of dental restoration models generated based on the dependency which are stored and accessed in the selection of one or more best shade match models.

The dependency is based on the Kubelka-Munk Theory of Reflectance and the present invention applied the Theory in a novel and advantageous manner to provide reflectance values of dental restoration models with different combinations of layers of different materials using individually measured reflectances of each material, without the need to physically arrange and measure the reflectance of each different combination, where such dental models include a simulated or natural tooth material with at least one layer of dental restorative material that may have other layer(s) of different dental restorative materials above it. Typically, one to two layers of dental restorative materials are used in a dental restoration, but the present invention is not limited to one or two layers and can readily adapt to account for multiple layers.

The relevant optical properties of the different translucent dental materials may include different color or translucency values. As one user-input parameter, a desired optical property of the restoration body when applied to the basic dental structure is provided. As another user-input parameter, a color or translucency value that is selected based upon optical properties of teeth adjacent of the basic dental structure is also provided. As an additional user-input parameter, a thickness of the dental restoration body to be produced is identified for at least one area of the basic dental structure which is relevant for the appearance of the dental restoration body. In accordance with the present invention, one or more dental materials are selected for the dental restoration body based upon the reference data and the dependency between the optical properties of the basic dental structure and the translucent dental materials.

A more detailed embodiment of the present invention includes a computer-implemented method and system for determining an appropriate translucent dental material or construction for use in producing a dental restoration for use with an existing dental structure. There are provided a data base containing optical properties of different translucent dental materials or constructions and a dependency between optical properties of the dental restoration, the existing dental structure and the translucent dental material or construction. Also included is an input routine adapted to receive information concerning a desired optical property, such as a color or translucency value, and the thickness of the dental structure to be produced. The desired optical property maybe based upon an optical property of teeth adjacent the existing dental structure. Further included is a selection routine adapted to determine an appropriate dental material(s) or construction for use in producing the dental restoration based upon a relationship between the desired optical property and thickness of the dental restoration, the optical properties of the existing dental structure and the translucent dental material(s) or construction. The relationship is a functional dependency or an empirical known dependency contained in look-up table(s). The computer implemented method may be incorporated in a shade determination device or installed in a stand-alone computer workstation.

The inventive measures described herein make it possible to accurately select translucent dental materials that will result in adequate final coloration of the dental restoration even though no opaque masking layer is employed. This feature is enabled through the use of reference dental templates that correspond to the materials used, the underlying tooth structures and to the order in which they are layered and to the thickness of each layer as well as the average thickness of the restoration to be fabricated. The comparison apparatus and method result in more precise, consistent color matching of the final dental restoration to that of the desired color than in previous methods that use translucent dental materials that do not include an opaque masking layer.

In accordance with the invention, it is advantageous to select simulated and/or natural tooth templates that include colors that correspond to the colors of teeth found in nature and to known dental color systems. Therefore, the simulated or actual tooth templates are created in a plurality of colors that correspond to the same. Likewise, it is particularly advantageous for the dental material templates to correspond in thickness and/or layering order to the thicknesses and layering orders that are commonly employed in the fabrication of dental restorations. The dental material templates are therefore created in varying thicknesses and the influence of one layer upon another is predicted via processes designed for this purpose in varying combinations that correspond to those commonly employed in practice.

In accordance with the invention, it is also advantageous to arrive at the appropriate materials to be used through an automated process. The relevant data is therefore displayed on a commonly available computer screen along with patient data information. The data may be converted to a printed format. In accordance with the invention, it is particularly advantageous for the data generated to be presented on the screen in one or more formats, including but not limited to numerical values, mapping of the coloration of the planned dental restoration overlaid on an outline of a tooth, alternate materials selections and their impact on the color match, user selectable color matching tolerance ranges and warnings when the tolerance ranges have been exceeded.

In accordance with the invention, it is advantageous for a variety of custom color matching processes to be user selectable, giving the user the option to increase or decrease the weight of individual parameters in the determination of an acceptable color match. The relative weight of parameters of material thickness, region of the tooth considered, material type(s), material layering order, variation of the overall or regional color of the prepped tooth, and predicted final dental restoration color, as well as any other parameter that is a part of the color matching formula employed, are all user adjustable. Thus, the present invention allows the user to custom tailor the functionality of the device to suit individual color matching needs

### BRIEF DESCRIPTION OF THE DRAWINGS

These and other features and advantages of the present invention will be better understood by reference to the following detailed description when considered in conjunction with the accompanying drawings wherein:

FIG. 1 is a side cross-sectional view of an underlying tooth structure with a dental restoration and an adjacent tooth.

FIG. 2 is a block diagram of an embodiment of a system in accordance with the present invention, including a processor or computer, with a storage area or database and a converter, a display, an input and a spectrophotometer.

FIG. 3a is a graph of reflectance values illustrating a reflectance curve of a tooth structure material.

FIG. 3b is a graph of reflectance values illustrating a reflectance curve of a dental restoration material.

FIG. 3c is a graph of reflectance values illustrating a reflectance curve of a combination of a tooth structure material and a dental restoration material.

FIG. 4 illustrates a plurality of tooth structure materials, each having Color/Shade designation, and a plurality of dental restoration materials, each having a Class and Color/Shade designation.

FIG. 4a is a plan view of a material (or template) of simulated tooth structure or of synthetically-grown natural tooth structure.

FIG. 4b is a plan view of a material (or template) of a cross section of natural tooth structure embedded in a fixation medium.

FIG. 5 is a flow diagram illustrating one process with functional dependency to predict or determine a best shade match for a dental restoration having a single dental restorative material that is applied to a selected tooth structure material.

FIG. 6 illustrates structures (or models) of prospective dental restorations using a selected tooth material as a base layer onto which different dental restorative materials are applied.

FIG. 7 illustrates structures (or models) of prospective dental restorations using different tooth materials as a base layer onto which different dental restorative materials are applied a first layer and as a second layer.

FIG. 8 is a flow diagram illustrating one process with functional dependency to predict or determine a best shade match for a dental restoration having two layers of dental restorative material that are applied to a selected tooth structure material.

FIG. 9 is a flow diagram illustrating one process with empirical dependency using look-up tables to predict or determine a best shade match for a dental restoration.

FIG. 10 is a flow diagram illustrating one process of generating look-up tables.

FIG. 11 is a flow diagram illustrating one process of comparing and selecting a best match shade.

FIG. 12 is a flow diagram illustrating one process of correcting measurements to account for measuring apparatus.

FIG. 13 is a flow diagram illustrating one process of a weighted color difference operation.

FIG. 14 is a view of a display providing a graphical representation of a dental restoration model structure identifying a tooth structure material representing an underlying tooth structure and two layers of dental restorative materials.

### DETAILED DESCRIPTION OF THE INVENTION

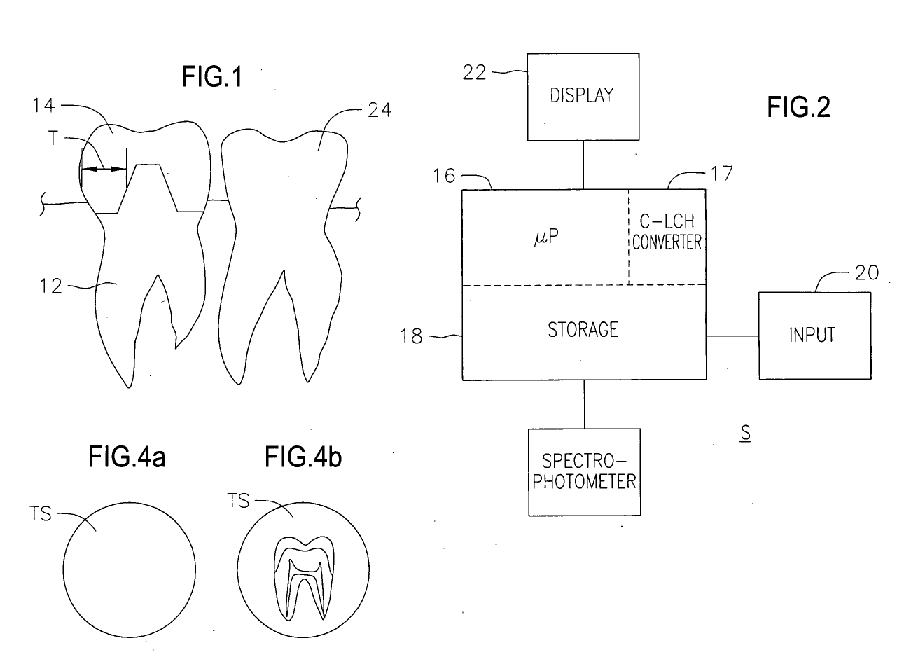

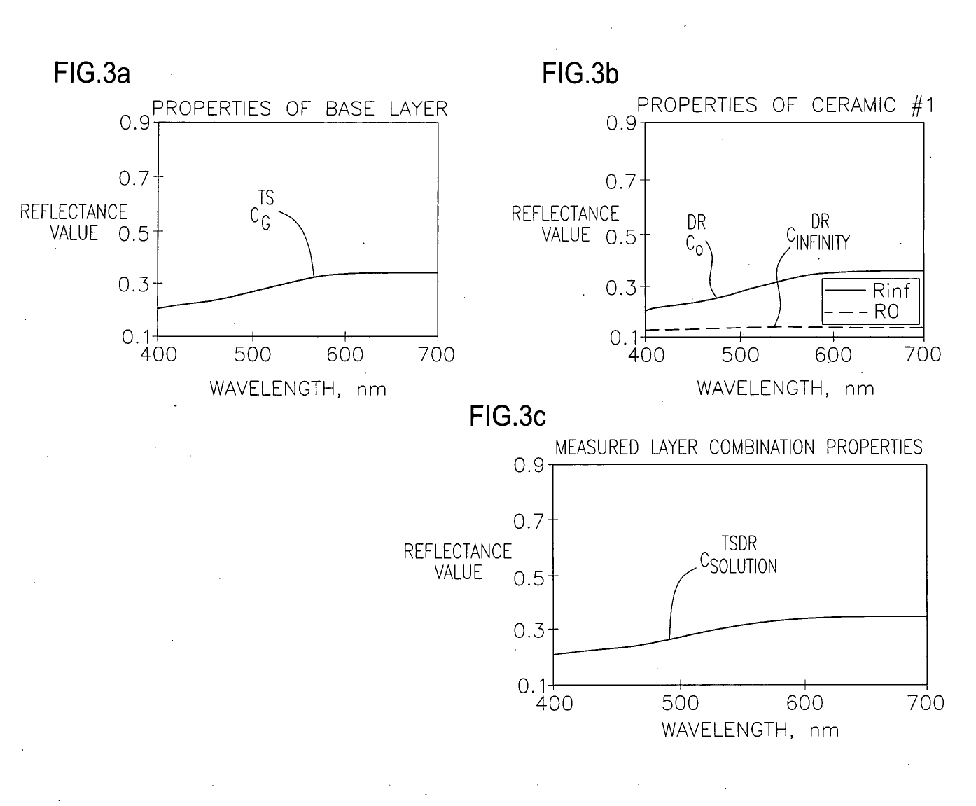

With reference to FIGS. 1 and 2, the present invention is directed toward a system S and method for measuring influence of an underlying tooth structure 12 in providing at least one proposed shade and/or construction of a dental restoration 14 with improved shade-matching where translucent restoration dental materials are used without an opaque layer. The underlying tooth structure 12 may be a prepped or reduced tooth, an abutment of an implant or any other structure known in dentistry for building an artificial tooth. The dental restoration 14 may include, without limitation, a crown, veneer, inlay, onlay, and the like that is to be applied to the underlying tooth structure 12.

In accordance with the present invention, pertinent optical properties of simulated or natural prospective tooth structure materials are measured. The optical properties of interest include but are not limited to reflectance and/or reflectivity of the materials. Likewise, pertinent optical properties of prospective dental restorative materials are measured. A selection of an ideal shade and dental restoration construction using a set of optical properties typical of teeth that represent shades (colors) is made on the basis of various user-input parameters that include an average thickness of the restoration in one or more predetermined regions, a desired (or target) shade of the dental restoration, and a shade of the underlying tooth that is to receive the dental restoration. In one embodiment, reflectance properties representative of shade (colors) and physical properties typical of teeth, including for example, an average thickness of the dental restoration in one or more user-selectable region(s), are inputted and stored for comparison with a “best-match” construction of a tooth structure material and one or more dental restorative materials that is constructed and selected in accordance with the present invention.

A method of the present invention includes the following generalized steps:
1) Provide a database of optical properties of tooth structure materials and dental restorative materials from which different shades can be generally predicted for dental restorations using different combinations of the tooth structure materials and dental restorative materials.
2) Receive user input parameters relating to optical and/or physical properties of an underlying tooth structure 12 and a dental restoration 14 therefor.
3) Based on at least one of the user-input parameters and a dependency between the optical properties of the tooth structure and dental restorative materials, select one or more shades as predicted for the combinations.

The prediction of a shade for a dental restoration combined of one tooth structure material and one or more dental restorative material(s) is accomplished via the application of the Kubelka-Munk Theory which recognizes a dependency in the optical properties of a background (or base layer) and a translucent layer that is applied to it. The dependency can be applied functionally or empirically, for example, to the reflectance of the background and translucent layer. In either case, the dependency allows a dental restorative material to assume the role of an applied translucent layer and a tooth structure material to assume the role of the background for the applied translucent layer. And, where a second dental restorative material is used, the second dental restorative material can assume the role of the applied translucent layer, and the tooth structure material and the first dental restorative materials can jointly assume the role of the background for the second applied translucent layer, and so on and so forth for successive applied translucent layers.

Accordingly, the dependency applied by the present invention involves the dependency of optical properties (e.g., reflectance) between an opaque base layer and an upper layer of a generally uniform translucent material in facilitating selection of dental restorative materials for improved shade-matching. Advantageously, the present invention aptly considers a plurality of combinations with multiple layers of different dental restorative materials on bases of different tooth structure materials by iteratively applying the dependency, as mentioned above.

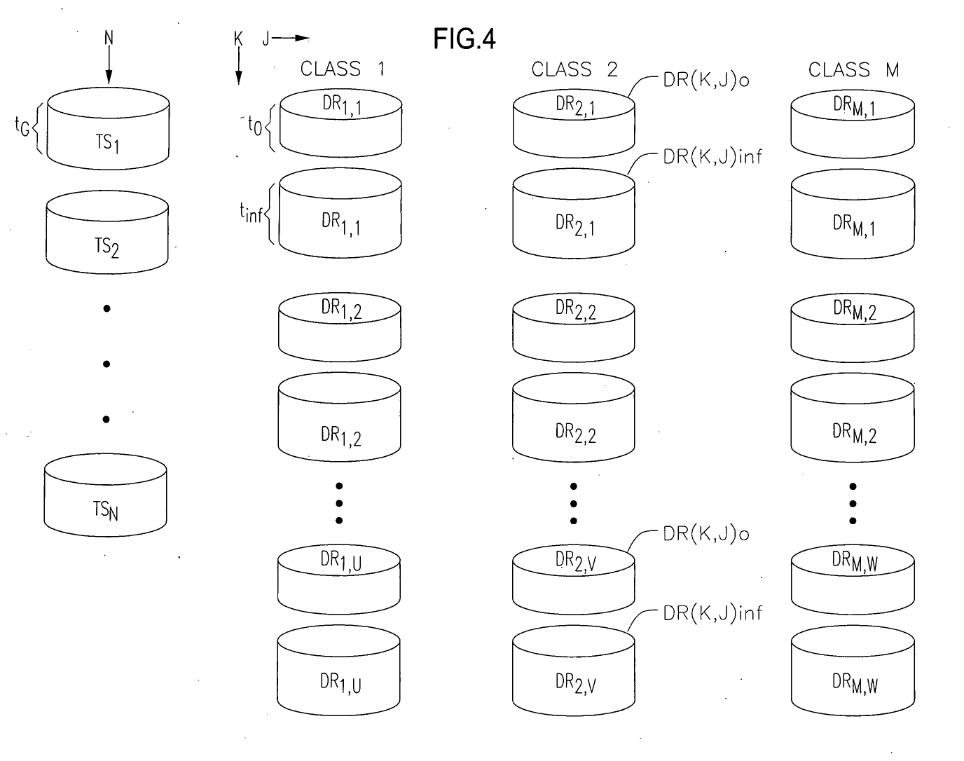

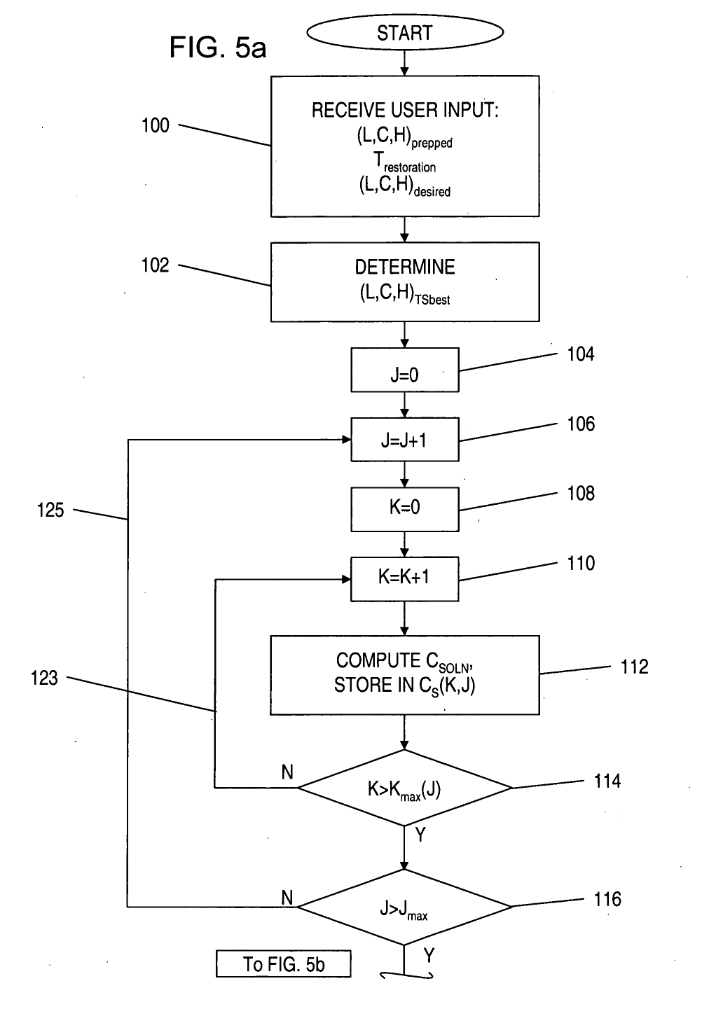

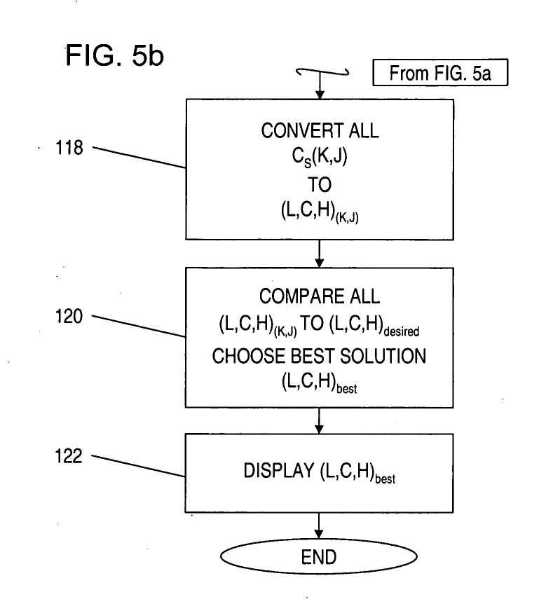

In the embodiment of FIG. 1, a system S of the present invention includes a processor 16 with a (L,C,H) converter 17 and at least one storage area 18, an input device 20 and a display 22, where measured data of relevant optical properties of different dental materials for use in expressing an optical dependency between the different dental materials are stored in the storage area 18 for use by the processor 16 to provide a user with at least one proposed shade and/or construction of a dental restoration that optimally matches a desired shade of the dental restoration. The system includes a spectrophotometer 26, that is adapted to measure and provide the relevant optical properties of the different dental materials, including reflectance and/or reflectivity R. Especially useful measurements can be made by the spectrophotometer at evenly spaced wavelength intervals of radiant light energy, between the range of about 400-700 nm as applicable for colorimetry science, or of UV light energy, between the range of about 320-400 nm for fluorescent materials, to provide a spectral reflectance curve C, such as that shown in FIGS. 3a-3c. The spectrophotometer is connected to the processor to provide measured data thereto.

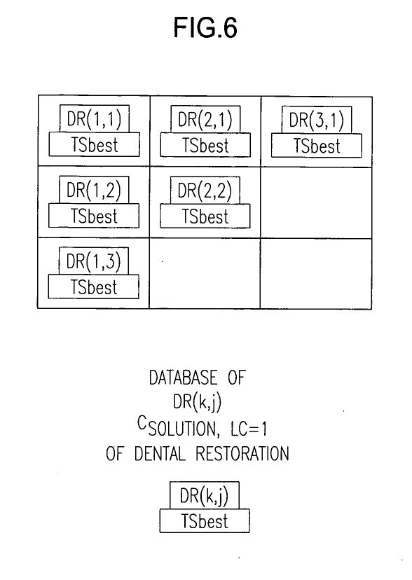

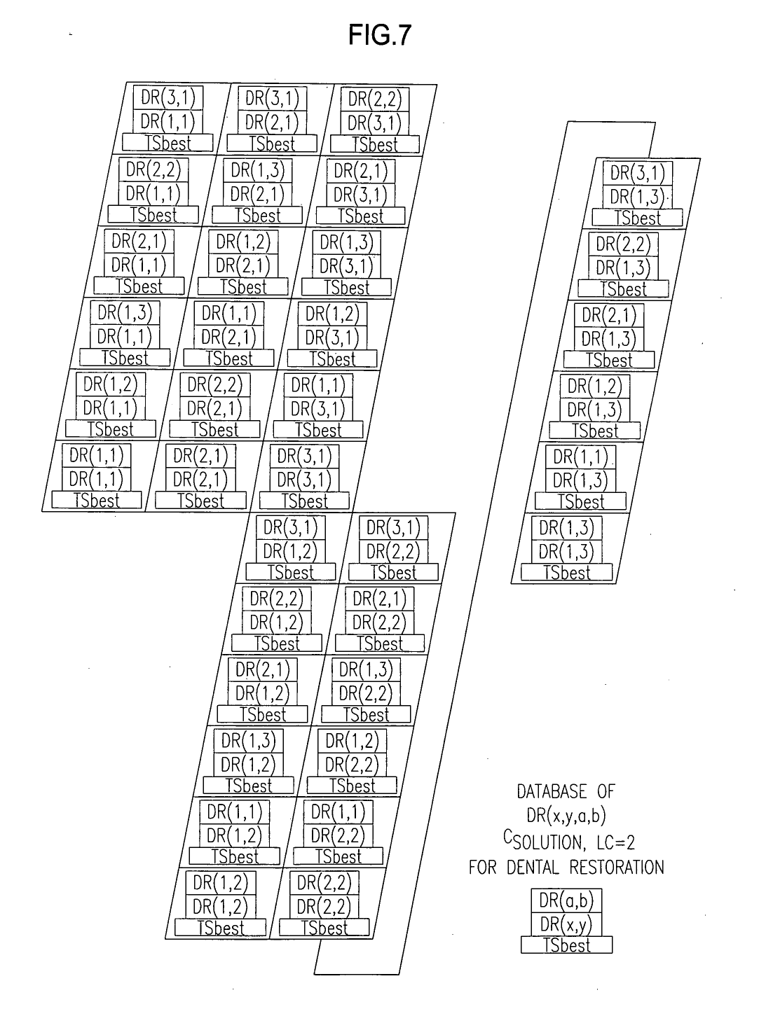

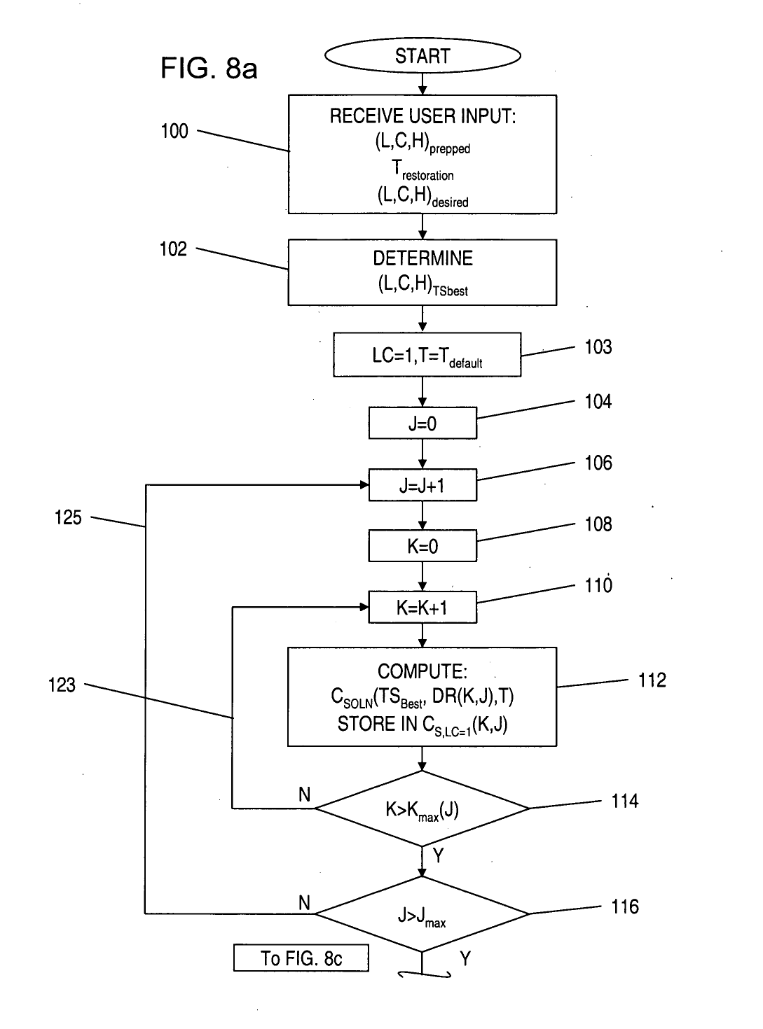

With reference to FIG. 4, the measured data of relevant optical properties of different dental materials stored in storage area 18 include pertinent optical properties (e.g., reflectance and/or reflectivity R) of simulated or natural tooth structure materials TS, and of dental restorative materials DR. The tooth structure materials TS serve to represent the underlying tooth structure 12, and the dental restorative materials DR serve to represent the translucent materials of which the dental restoration 14 can be constructed.

The tooth structure materials TS whose measured optical properties are used by the present invention may be constructed of synthetic composite resin material (see FIG. 4a) or have a natural tooth structure (e.g., a human or animal tooth encased in acrylic) (see FIG. 4b). A variety of tooth structure materials TS1-TSN of different shades is used by the system S to simulate possible different shades of the underlying tooth structure 12 on which the dental restoration 14 is to be applied. As recognized by the present invention, it is advantageous to provide tooth structure materials that include colors that correspond to the colors of teeth found in nature and known to dental color systems. Therefore, the tooth structure materials TS used by the system are provided in a plurality of colors that correspond to the same.

To facilitate an expression of the optical dependency between the tooth structure materials TS and the dental restorative materials DR, each tooth structure material TS is configured with a height (or thickness t_{G}) that is sufficient to render it suitable for optical measurement as a reflectance R_{G} of a background (or opaque base layer) to which a layer of dental restorative material DR is applied. Such thickness may range between about 2.0 mm and 20.0_mm, and more preferably between about 5.0 mm and 12.0 mm. Accordingly, a spectral reflectance curves C_{G} (FIG. 3a) is provided based on the measured reflectance R_{G} of each tooth structure material TS at evenly spaced wavelength intervals (e.g., increments of 10 nm) of radiant light energy between about 400-700 nm (or of UV light between about 320-400 nm). The resulting reflectance curves C^{TS}_{G} are stored in the storage area for use by the processor

Thus, for the tooth structure materials TS₁-TS_{N} (where N ranges between about 4-100, and preferably ranges between about 4 and 20, and more preferably between 6 and 12), their respective reflectance curves. C^{TS1}_{G}-C^{TSN}_{G} are stored in the processor. In the disclosed embodiment, the reflectance curves C^{TS1}_{G}-C^{TSN}_{G} are available for use by the processor 16 in representing reflectance of the respective tooth structure materials TS as a background (or an opaque base layer) to which one or more layer(s) of translucent dental restorative material DR are applied in structuring prospective dental restoration models from which one or more models having the optimum shade match are selected by the processor. As understood by one of ordinary skill in the art, the terms “shade” and “color” are used interchangeably herein.

The dental restorative materials DR whose measured optical properties are used by the present invention may be constructed of ceramics, composites, acrylics, or other translucent polymeric or monomeric compounds, representing a variety of Classes and Colors. As also recognized by the present invention, it is advantageous to use dental restoration materials that include colors that correspond to the colors of teeth found in nature and known to dental color systems. Therefore, the dental restorative materials DR are provided in a plurality of colors that correspond to the same.

In the disclosed embodiment of FIG. 4, a variety of dental restorative materials DR are categorized by Classes 1-M (where multiple Classes are provided), and by respective Colors 1-U, 1-V and 1-W, where U, V, W may range between about 2 and 100, preferably between about 10 and 30, and more preferably between about 4 and 10. It is recognized by the present invention the advantages of using commercially available dental restorative materials or those commonly employed for the fabrication of dental restorations as the measured dental restorative materials DR. It is understood by one of ordinary skill in the art that any one of the materials DR may be used in the present invention for the entirety of the dental restoration 14 to be applied to the underlying tooth structure 12, or in different layer combinations for different multi-layered dental restorations.

To facilitate an expression of the optical dependency between the tooth structure materials TS and the dental restorative materials DR, each dental restorative material DR(k=color, j=class) of Class j and Color k has two different members for two different measurements of its optical properties. As illustrated in FIG. 4, one measurement R^{DR}₀ is of one member having a thickness Tₒ that is representative of an average thickness commonly used in construction of a dental restoration (e.g., between about 0.25 mm and 3.50 mm, preferably between about 0.50 mm and 2.00 mm, and more preferably about 1.25 mm) (FIG. 2a). These dental restorative material DR₀ are configured as wafer or discs, each having a measurement surface that is flat and sanded to a matte finish. The other measurement R^{DR}_{infinity} is of the other member DR_{inf} having a sufficient thickness such that a further increase in thickness would not result in a change in the measured optical property (e.g., between about 5.0 mm and 20.0 mm, and more preferably between about 10.0 mm and 15.0 mm).

By measuring R^{DR}₀ and R^{DR}_{infinity} for each DR(k,j) at evenly-spaced wavelength intervals, a spectral reflectance curve C^{DR(k,j)}₀ of measured optical property R^{DR(k,j)}ₒ and a spectral reflectivity curve C^{DR(k,j)}_{infinity} of measured optical property R^{DR(k,j)}_{infinity} (see FIG. 3b) are provided for each dental restorative material DR(k,j) of Class J and Color K. It is understood by one of ordinary skill in the art that when a material is measured at R_{infinity}, the resultant data is typically distinguished by using the term reflectivity rather than reflectance. Accordingly, the terms reflectance and reflectivity are used interchangeably as appropriate herein.

These curves C^{DR}₀ and C^{DR}_{infinity} are available for use by the processor in representing the reflectance and reflectivity, respectively, of the respective dental restorative materials DR as a first or second layer that is applied to a tooth structure material TS in structuring prospective dental restoration models from which one or more models with optimum shade match are selected by the processor. It is advantageous for the dental restorative materials to correspond in thickness and/or layering order to thicknesses and layering orders that are commonly employed in the fabrication of dental restorations.

It is noted that when measuring the value R^{DR}₀, the dental restorative material DR is coupled to a suitably black background via an optically transparent coupling medium, for example glycerine. Moreover, to minimize variations within a manufacturing lot of all tooth structure materials TS and dental restorative materials DR, multiple materials of each Class and/or Color are used and multiple measurements of each individual material are taken. For example, an average of ten dental restorative materials DR of each Class/Color are used, whereby each individual sample DR is measured three times.

Once provided and stored as data in the storage area, the reflectance curves C^{TS}_{G} for each tooth structure material TS, and the reflectance curves C^{DR}₀ and C^{DR}_{infinity} for each dental restorative material DR may be retrieved and used in expressing the optical dependency between the materials TS and DR in structuring models of the dental restoration 14 with optimum shade matching.

In accordance with a feature of the present invention, the optical dependency between a tooth structure material TS and a translucent layer of dental restorative material DR applied to the tooth structure material TS can be expressed as follows, using Kubelka-Munk Theory of Reflectance:

$${R}_{Solution} = \frac{\frac{{R}_{G}^{TS} - {R}_{inf}^{DR}}{{R}_{inf}^{DR}} - {R}_{inf}^{DR} ( {R}_{G}^{TS} - \frac{1}{{R}_{inf}^{DR}} ) exp [ ST ( \frac{1}{{R}_{inf}^{DR}} - {R}_{inf}^{DR} ) ]}{{R}_{G}^{TS} - {R}_{inf}^{DR} - ( {R}_{G}^{TS} - \frac{1}{{R}_{inf}^{DR}} ) exp [ ST ( \frac{1}{{R}_{inf}^{DR}} - {R}_{inf}^{DR} ) ]} \qquad EQN 1$$

where

R_{Solution}=top reflectance of dental restorative material DR with thickness T having a background reflectance R^{TS}_{G} of tooth structure material TS;

R^{DR}_{inf}=measured reflectance of a very thick material DR (a material property called reflectivity)

S=scattering coefficient of material DR and is defined as follows:

$$\begin{matrix}S = \frac{( \frac{1}{{R}_{inf}^{DR}} + {R}_{inf}^{DR} ) coth ( \frac{1 - ( \frac{1}{{R}_{inf}^{DR}} + {R}_{inf}^{DR} ) \frac{{R}_{0}^{DR}}{2}}{( \frac{1}{{R}_{inf}^{DR}} - {R}_{inf}^{DR} ) \frac{{R}_{0}^{DR}}{2}} )}{T ( \frac{1}{{R}_{inf}^{DR}} - {R}_{inf}^{DR} )} \\ if \frac{1 - ( \frac{1}{{R}_{inf}^{DR}} + {R}_{inf}^{DR} ) \frac{{R}_{0}^{DR}}{2}}{( \frac{1}{{R}_{inf}^{DR}} - {R}_{inf}^{DR} ) \frac{{R}_{0}^{DR}}{2}} > 1 \\ and & EQN 2 a \\ S = \frac{( \frac{1}{{R}_{inf}^{DR}} + {R}_{inf}^{DR} ) coth ( 1.01 )}{T ( \frac{1}{{R}_{inf}^{DR}} - {R}_{inf}^{DR} )} if \frac{1 - ( \frac{1}{{R}_{inf}^{DR}} + {R}_{inf}^{DR} ) \frac{{R}_{0}^{DR}}{2}}{( \frac{1}{{R}_{inf}^{DR}} - {R}_{inf}^{DR} ) \frac{{R}_{0}^{DR}}{2}} \leq 1 & EQN 2 b\end{matrix}$$

where

R₀=the reflectance of the layer of material DR with thickness T₀,

The reflectance values Rₛₒₗᵤₜᵢₒₙ used are measured at evenly spaced wavelength intervals to provide a solution reflectance curve Cₛₒₗᵤₜᵢₒₙ. As recognized by the present invention, the expression EQN1 may be used iteratively for additional successive dental restorative layers, where the reflectance Rₛₒₗᵤₜᵢₒₙ would be used as the backing or substrate reflectance R_{G} for additional dental restorative layer, and so on and so forth for further additional restorative layers.

To apply the expression EQN1, the system is configured to receive various user input-parameters, including: (1) a shade of the underlying or prepped tooth structure 12, (2) a desired shade of the dental restoration 14 as how it will appear on the underlying tooth structure, and (3) an average thickness T of the dental restoration in area(s) of interest (also known as the target zone) (see FIG. 1). These parameters (which need not be entered in any particular sequence) are entered into the system via the input device 20.

The shade parameter of the prepped tooth can be obtained through a variety of conventional means, including the use of any commercially-available dental shade guide system, or the spectrophotometer 26, to provide an alphanumeric shade value, for example, in the format of (#, letter, #) wherein the number on the left represents a Lightness value, the number on the right represents a Chroma value and the letter represents a Hue value, in keeping with the XYZ CIELAB Color System.

The desired shade parameter of the dental restoration 14 can be also be obtained through a variety of conventional means, including the use of any commercially-available dental shade guide system, or the spectrophotometer 26, that can be applied to the adjacent teeth 24. The format would also be in the number/letter/number format (#,letter,#).

The target zone for purposes of determining an average thickness parameter may be defined as area(s) of the prepped tooth 12 which is relevant for the appearance of the dental restoration 14 which can be selected by the user. For instance, the middle one third of the labial surface of the tooth may be selected as the target area for anterior teeth whereas the occlusal surface might be considered preferable for posterior teeth. In one embodiment, an average thickness and/or coloration measurements in the target area is considered in color matching calculation for selecting the dental restorative materials. After the target area is identified, the average thickness T may be measured in a variety of conventional means, including, via a physical measurement of a wax pattern of the underlying tooth structure 12, a digital measurement of a virtual restoration, or any other method the user selects. The average thickness T may range between 0.20 mm and 3.50 mm, and more preferably between 0.50 mm and 2.50 mm.

### Functional Dependency

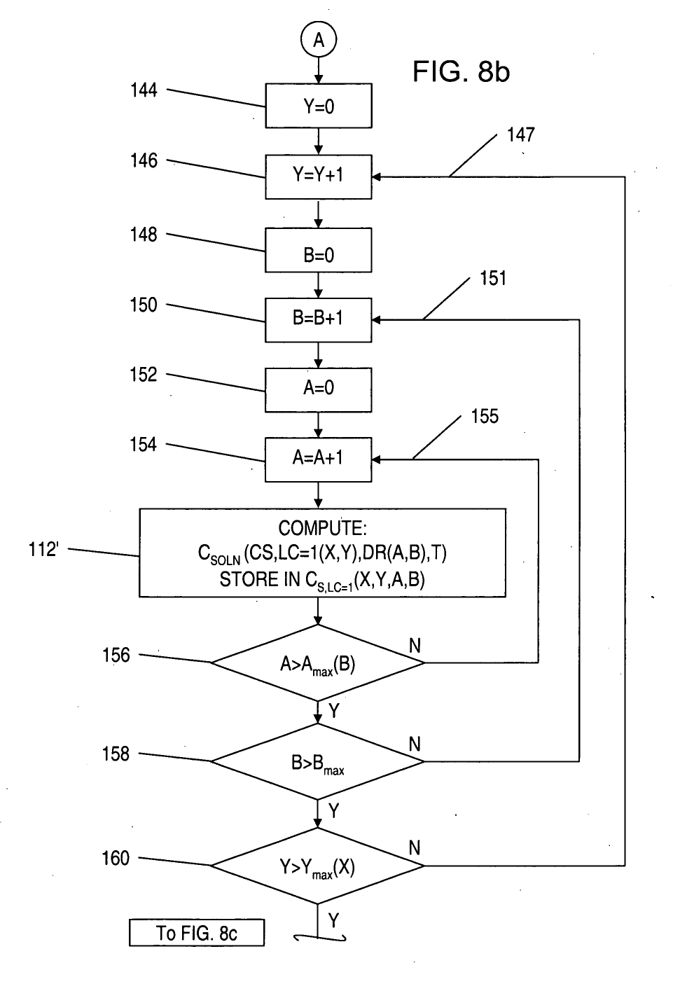

With reference to FIG. 4, the flow diagram of FIG. 5 demonstrates an embodiment of the system S operating with functional dependency to predict or determine one or more best shade match(es) for a dental restoration made of a single dental restorative material DR. Stored in the database are reflectance curves C^{TS1}_{G}-C^{TSN}_{G} for tooth structure materials TS₁-TS_{N}. Also stored in the database are reflectance/reflectivity curves C^{DR(k,j)}₀ and C^{DR(k,j)}_{infinity} for dental restorative materials of Classes j (j ranging from 1-M), each of which has a different plurality of Colors k (k ranging from 1-U for Class 1, 1-V for Class 2, . . . , and 1-W for Class M. To simplify the discussion herein, U=3, V=2 and M=1.

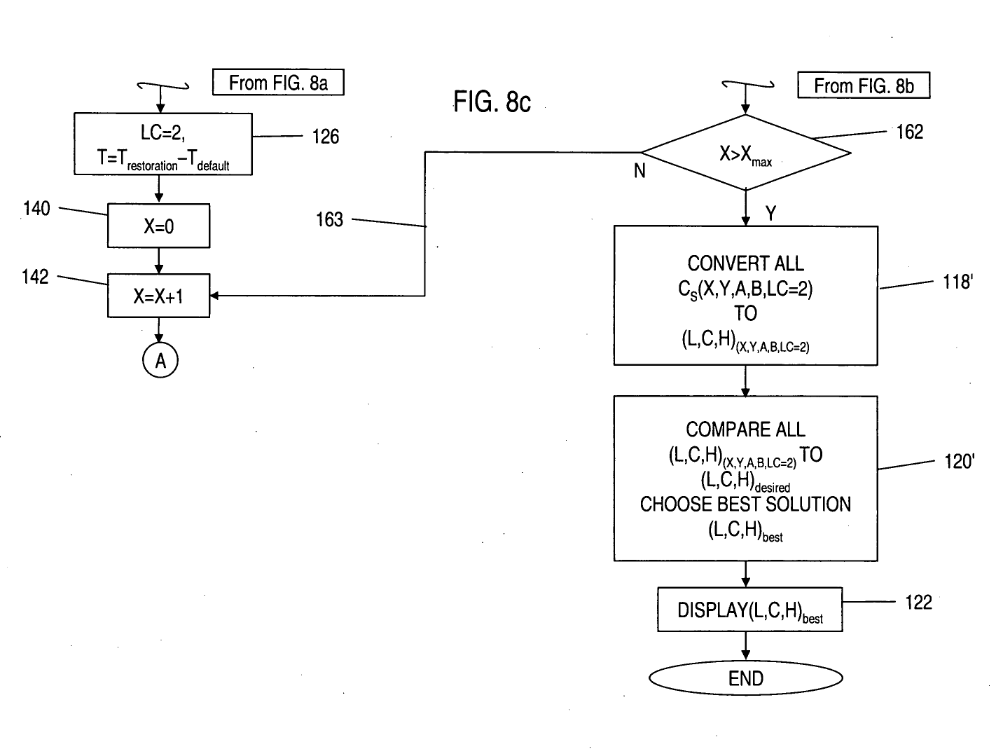

In Step 100, the system receives the user-input parameters of shade value (L,C,H)_{prepped} of the prepped tooth 12, the desired shade value (L,C,H)_{desired} of the dental restoration 14, and the average thickness Tᵣₑₛₜₒᵣₐₜᵢₒₙ of the target area. In Step 102, the processor compares the (L,C,H)_{desired} value to all stored (L,C,H)^{TS1}-(L,C,H)^{TSN} values of tooth structure materials TS₁-TS_{N} that have been converted by the C/LCH converter 17 from the stored reflectance curves C^{TS1}_{G}-C^{TSN}_{G}. Included in Step 102, an (L,C,H)^{TSbest} value that best matches the (L,C,H)_{prepped} value is identified and its corresponding reflectance curve C^{TSbest}_{G} is retrieved from the database 18. In Steps 104, 106, 108 and 110, the processor is initialized and configured to process each of the materials DR(k,j). In Step 112, the processor 16 applies the expression EQN1 using the thickness Tᵣₑₛₜₒᵣₐₜᵢₒₙ, the reflectance curve C^{TSbest}_{G} (as a background reflectance), and the reflectance curves C^{DR(k,j)}₀ and C^{DR(k,j)}_{infinity} (as the reflectivity of the layer the DR material being applied) to generate a solution reflection curve Cₛₒₗᵤₜᵢₒₙ which is stored in the database as Cs(k,j) (see FIG. 6).

Queries 114 and 116 enable Step 112 to use the reflectance curves C_{G} and C₀ of each dental restorative material DR(k,j). Loop 123 between Steps 114 and Step 110 enable the appropriate permutations of indices so that all Colors of dental restoration materials with in one Class are used. Likewise, Loop 125 between Steps 116 and Step 106 is provided so that all Classes of dental restoration materials are used. And, when dental restorative materials of all Classes and Colors have been used in the operation of Step 112, all solution reflectance curves CsDR(k,j) are converted to shade values (L,C,H)_{solution(k,j)} by the converter 17 in Step. 118. In Step 120, all (L,C,H)_{(k,j)} are compared to the user input parameter (L,C,H)_{desired} and one or more best match converted values (L,C,H)_{best} are selected by the processor to represent the corresponding combination(s) of materials TS and DR that produce final shade(s) best matching the user-input desired shade (L,C,H)_{desired} for the dental restoration. This method enables the processor to apply the expression EQN1 using the same reflectance curve C^{TSbest}_{G} and thickness Tᵣₑₛₜₒᵣₐₜᵢₒₙ while rotating through all of the available reflectance/reflectivity curves C^{DR(k,j)}₀ and C^{DR(k,j)}_{infinity}. Thus, the processor is structuring multiple dental restorations each with the material TS_{best} as background, and using different dental restorative materials DR(k,j) as the layer applied to the background to provide different solution reflectance curves. In Step 122, the (L,C,H)_{best} value(s) are displayed.

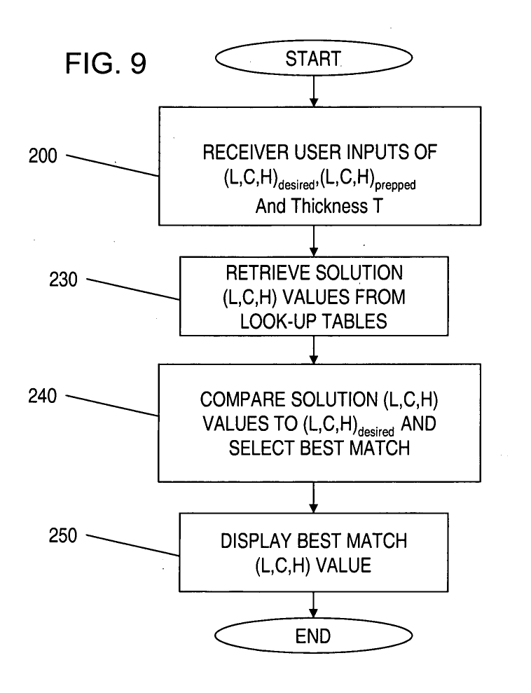

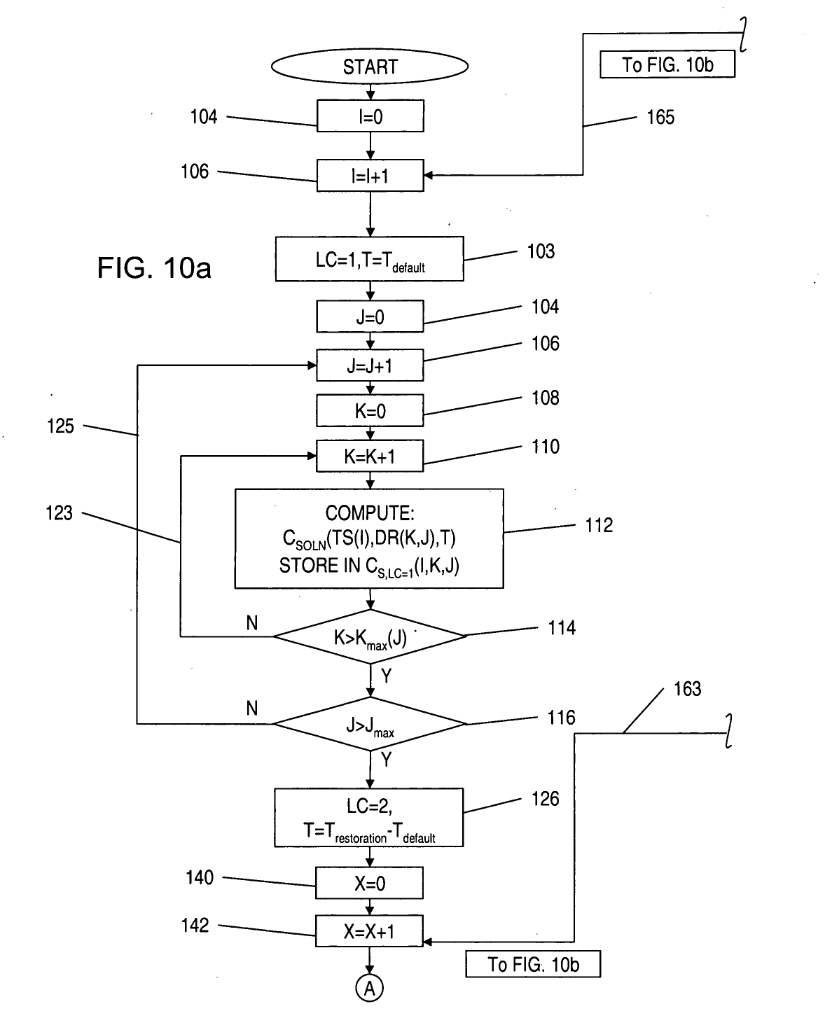

The foregoing operation is for use in creating or structuring single layer dental restorations, where the dental restoration 14 is to be made of a single dental restorative material DR(k,j) (such as shown in FIG. 6). Where it is desirable that the dental restoration have an inner layer, e.g., a coping, and an outer layer of dental restorative materials, reference is made to FIG. 7 and the flow diagram of FIG. 8 where similar steps are designated by same reference numerals. Again to simplify the discussion herein, the colors of each class of dental restorative materials are taken to be U=3, V=2 and W=1.

From Step 100 to Step 116, the method of FIG. 8 resembles that of FIG. 5 in generating and storing reflectance curves C^{TSbestDR}(k,j)ₛₒₗᵤₜᵢₒₙ. However, in Step 103, the thickness T for a first layer of dental restorative material DR(k,j) is set as thickness T_{default} selected or predetermined by the user (with the constraint that T_{default} is less than input parameter Tᵣₑₛₜₒᵣₐₜᵢₒₙ). Also, in Step 103, a layer count value LC of “1” is set to track the layer of DR material as a first DR layer. In Step 126, after the expression EQN1 has been applied to all dental restorative materials DR(k,j) with tooth structure material TS_{best}, the layer counter LC is set to “2” and the layer thickness T is set to the difference between Tᵣₑₛₜₒᵣₐₜᵢₒₙ and T_{default} so as to account for the thickness of the first layer. In Steps 140, 142, 144, 146, 148, 150 152 and 154, new indices (x,y) and (a,b) are introduced and initialized so that Step 112′ can apply expression EQN1 to all permutations of the dental restorative materials DR(a,b) as an additional layer that is applied to “a new” base layer of the tooth structure TS_{best} and dental restorative materials DR(x,y). To that end, Queries 156, 158, 160 and 162, and Loops 163, 147, 151 and 155 facilitate such permutations in Step 112′. In accordance with the present invention, in Step 112′, the expression EQN1 is applied using the data from solutions C_{S,LC=1}(k,j) derived from Step 112 as the background reflectance R_{G} for each material DR(a,b), and the solutions from Step 112′ are stored as C_{S,LC=2}(x,y,a,b) (see FIG. 7).

When dental restorative materials of all Classes and Colors have been used in the operation of Step 112′, all solution reflectance curves Cs_{,LC=2}(x,y,a,b) (also designated as C_{s,LC=2}DR(x,y,a,b)) are converted to shade values (L,C,H)_{(x,y,a,b,)} by the converter 17 in Step. 118′. In Step 120′, all (L,C,H)_{solution (x,y,a,b,)} are compared to the user input parameter (L,C,H)_{desired} and a best match converted value (L,C,H)_{best} is selected by the processor to represent the corresponding combination of materials TS and DR that produces a shade best matching the user-input desired shade (L,C,H)_{desired} for the dental restoration with two layers of different dental restorative materials DR. This method enables the processor to apply the expression EQN1 using the same reflectance curve C^{TSbest}_{G} and thickness T_{default} while rotating through all of the available reflectance/reflectivity curves C^{DR(k,j)}₀ and C^{DR(k,j)}_{infinity} when the layer count is “1”, and to apply the Expression EQN1 using all solution reflection curves C_{s,LC=1}(k,j) from Step 112 (reindexed as C_{s,LC=1}(x,y) in Step 112′) and thickness difference (=Trestoration−Tdefault) with all of the available reflectance/reflectivity curves C^{DR(a,b)}₀ and C^{DR(a,b)}_{infinity} when the layer count is “2”. Thus, the processor is structuring numerous dental restorations each with the material TS_{best}, but using different dental restorative materials DR as the initial and additional layers of a multi-layer dental restoration. In Step 122, the (L,C,H)_{best} value is displayed.

In the illustrated embodiments, the flow chart of FIG. 8 varies from the flow chart of FIG. 5 in several aspects, including (without any particular order in the degree of significance) a distinction in the thickness T that is used in the operation of Steps 112 and 112′ depending on whether the layer of dental restorative material DR being applied is an initial layer above the base layer of tooth structure, or an upper layer to be added to a combination of an initial layer of dental restorative material DR above a base layer of tooth structure material TS. Another difference is the use of a layer counter LC value is provided and used primarily to designate whether the layer of dental restorative material is being applied as an initial layer, or as an upper layer. But in both embodiment, the method provides a best match value (L,C,H)_{best} that represents the combination of materials TS and DR that produces one or more shade(s) best matching the user input desired shade for the dental restoration.

It is understood by one of ordinary skill in the art that the present invention also considers the selection of different combinations of tooth structure and dental restorative materials to provide a ranking of possible choices, for example, the top five combinations, starting from a best shade match that is followed by other shade matches that are less close to the desired shade. The method and system of the present invention can readily accommodate the selection of such multiple combinations to present to the user for a final selection by the user.

### Empirical Dependency

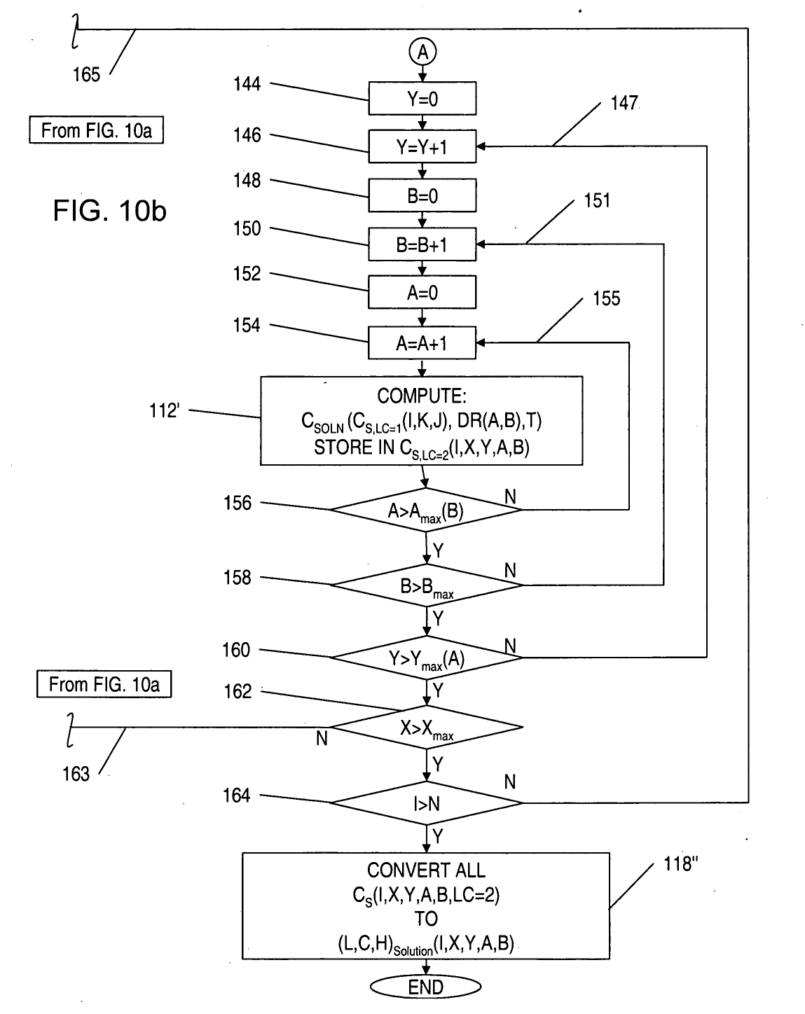

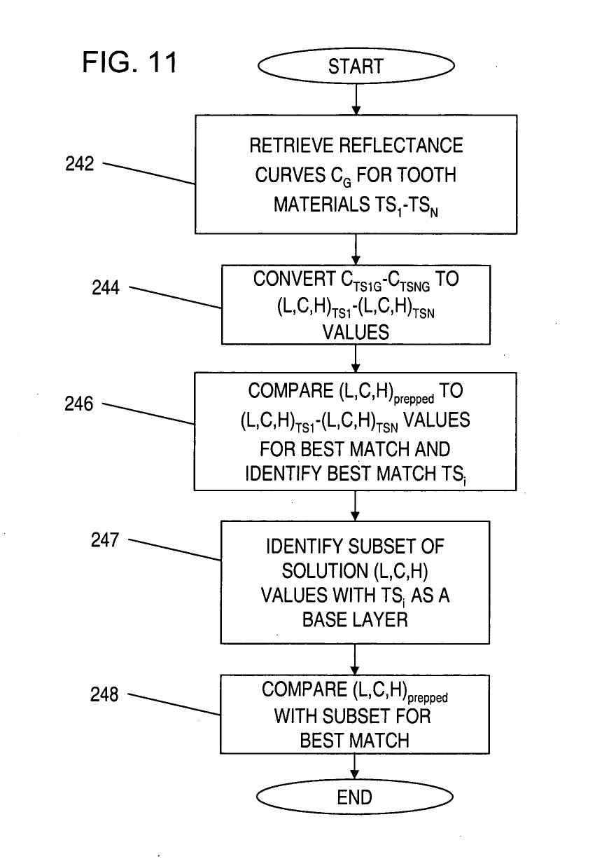

The flow diagram of FIG. 9 demonstrates an embodiment of the system operating with empirical dependency to predict or determine a best shade match for a dental restoration made of a two layers of dental restorative material DR. Stored in the database are reflectance curves C^{TS1}_{G}-C^{TSN}_{G} for tooth structure materials TS₁-TS_{N}. Also stored in the database are reflectance/reflectivity curves C^{DR(k,j)}₀ and C^{DR(k,j)}_{inf} for dental restorative materials of Classes j (j ranging from 1-M), each of which has a different plurality of Colors k (k ranging from 1-U for Class 1, 1-V for Class 2, . . . , and 1-W for Class M. Further stored in the form of look-up tables are solution (L,C,H) values converted from solution curves C_{s,LC=2}(i, x,y,a,b,) representing all possible combinations of the tooth structure material TSi as the base layer and DR(x,y) as the first layer on the base layer and DR(a,b) as the second layer. As discussed further below, the flow diagram of FIG. 10 illustrates one embodiment of generating such (L,C,H) values and solution curves. As understood by one of ordinary skill in the art, an alternate embodiment may store the converted (L,C,H) values as look-up tables without storing the solution curves or any application or operation of expression EQN1.

In Step 200, user input parameters are received including a desired shade for the dental restoration (L,C,H)_{desired} and a shade of the underlying tooth structure (L,C,H)_{prepped}. In Step 230, solution (L,C,H) values converted from solution curves C_{s,LC=1}(x,y,a,b) are retrieved from look-up tables. In Step 240, retrieved solution (L,C,H) values are compared with the user input (L,C,H)_{desired} for one or more best match(es), which are displayed in Step 250.

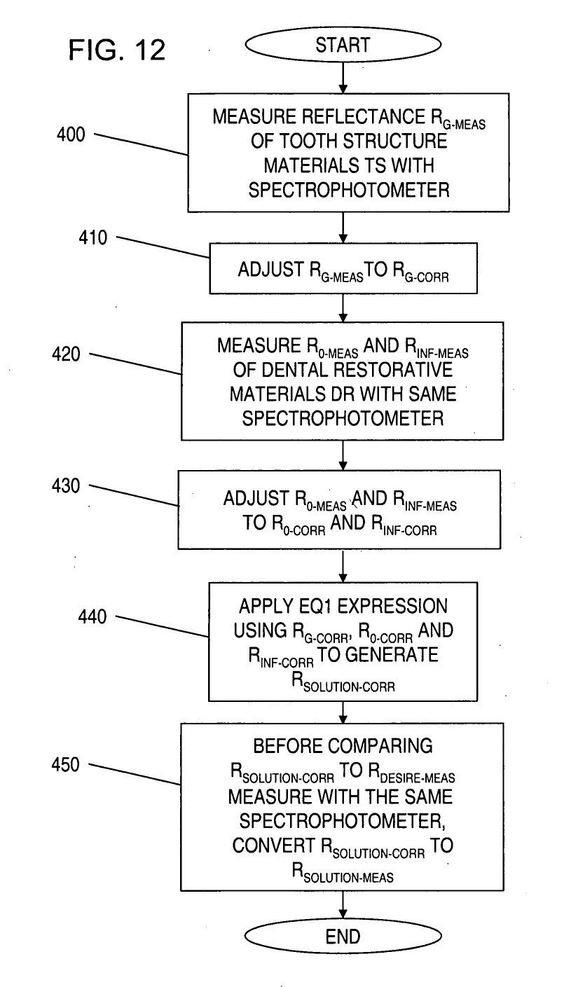

In one embodiment, Step 240 can include the substeps shown in FIG. 11. In Step 242, reflectance curves C_{G} for tooth materials TS₁-TS_{N} are retrieved and converted to (L,C,H)_{TS1}-(L,C,H)_{TSN} which are in Step 246 compared to the (L,C,H)_{prepped} of the underlying tooth for a best match. A best match TS_{best} is identified, and is used in Step 247 to identify a subset of solution (L,C,H) values with TS_{best} as a base layer. In Step 248, the (L,C,H)_{prepped} of the underlying tooth is compared to that subset for one more best match(es). As understood by one of ordinary skill in the art, the Step 240 comparison in an alternate embodiment can be applied over all possible (L,C,H) solution values for all materials TS1-TSN as the base layer and DR materials as the first and second applied layers (such as those converted from reflectance curves generated by the process of FIGS. 10a and 10b, and not merely for those solutions with TSbest as the tooth structure material, as illustrated in FIG. 11).

As for setting up the look-up table of all possible combinations of materials TS₁-TS_{N} as the base layer and materials DR as the first and second applied layers, the flow diagram of FIG. 10 illustrates one process. The processes of FIG. 10 and of FIG. 10 have similarities and thus similar Steps are designated by similar reference numerals. However, one difference is the indexing of tooth structure materials TSᵢ in Step 166, which with Loop 165, allows application of the process to each of TS₁-TS_{N}. Accordingly, in Steps 112, 112′ and 118′, the respective solution curves Cₛ are indexed also by “i” so as to distinguish between different tooth structure materials TSᵢ.

### Additional User-Input Parameters

In alternative embodiments, additional user-input parameters may include a number of layers N, layering order of the dental restorative materials, thickness range(s) of individual layer(s), and selection of shade guides. As understood by one of ordinary skill in the art, the method and system of the present invention can readily accommodate multiple layers of dental restorative materials beyond the two layers discussed herein. Moreover, the method and system can readily accommodate a layering order parameter that is dependent on translucency of the dental restorative materials, where less translucent materials are used in the lower layer(s) followed by more translucent materials in the upper layer(s). As for the thickness parameter where multiple layers of dental restorative materials are considered, the method and system can also readily accommodate a changing thickness T (e.g., increasing or decreasing) for each additional layer of dental restorative material.

Further additional user-input parameters can also include user-determined limitations on the tooth structure and/or dental restorative materials TS and DR that can be considered for use by the method and system of the present invention. For example, depending on various factors including material availability, and user's personal choice, it may be desirable to exclude certain tooth structure and/or dental restorative material as candidates for use in the structuring and modeling of the dental restoration. To that end, the processor can be configured to facilitate selections and/or exclusion constraints imposed by the user, for example, via pull-down menus or other window-based operations to facilitate the selection or exclusion of certain materials TS and/or DR.

The aforementioned inputs form a set of constraints that operate on a selection process in accordance with the present invention, where the combination(s) of dental restorative materials 18 that result in the desired final shade are proposed based on processes and implementations optimized for this purpose.

### Saunderson Correction

A spectrophotometer illuminates an object from a light source that is situated in the air, with the light passing through the air and into the object itself. Some of the light is reflected back out of the object and back through the air to a sensor generating a reading. Because air and the object have different refractive indices the angle of incidence and speed of the light changes as the light moves from one medium to another. Thus, it is desirable to provide a correction in measurements made in the present invention of generating a final reflectance of multiple layers of materials with different refractive indices that are fused or otherwise joined to each other with no air gap in between, such as dental restorations with a tooth structure base and one or more dental restorative layers applied thereto.

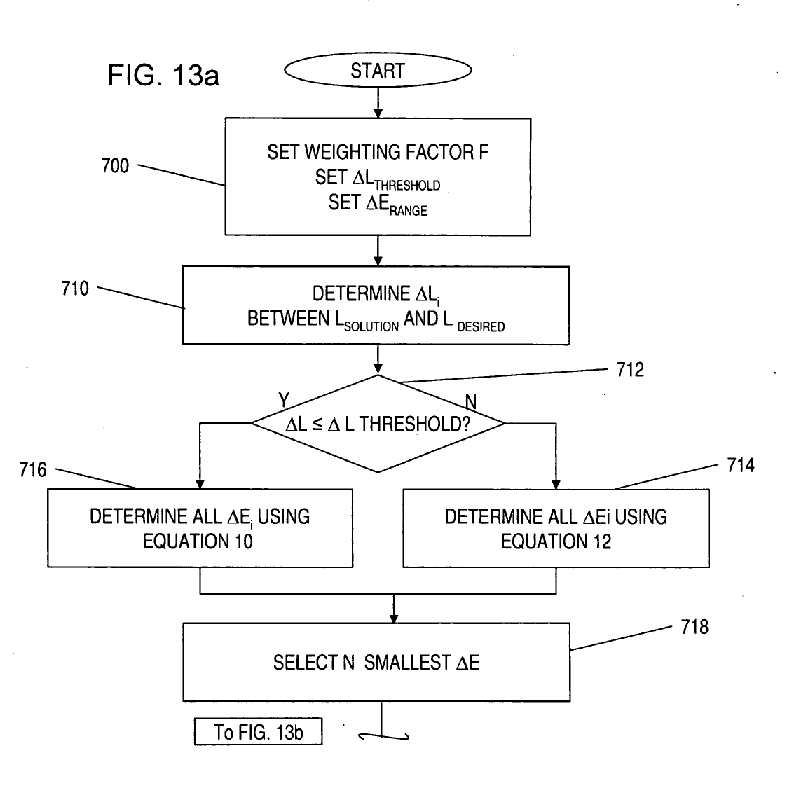

The flow diagram of FIG. 12 illustrates one embodiment of a correction method. In Step 400, the reflectances R_{G-MEAS} of the tooth structure materials TS at evenly spaces wavelength intervals (forming reflectance curve C_{G-MEAS}) is measured with a spectrophotometer. In Step 410, the reflectances R_{G-MEAS} are corrected to R_{G-CORR}. (forming reflectance curve C_{G-CORR}). In Step 420, the reflectances/reflectivities R_{0-MEAS} and R_{INF-MEAS} of the dental restorative materials DR (forming reflectance/reflectivity curves C_{0-MEAS} and C_{INF-MEAS}) are measured with the same spectrophotometer. In Step 430, the reflectances/reflectivities R_{0-MEAS} and R_{INF-MEAS} are corrected to R_{0-CORR} and R_{INF-CORR} (forming C_{0-CORR} and C_{INF-CORR}). In Step 440, solution reflectances R_{SOLUTION-CORR}, are generated via application of equation EQN1 using R_{G-CORR}, R_{0-CORR} and R_{INF-CORR}. In Step 450, the reflectances R_{SOLUTION-CORR} are converted to R_{SOLUTION-MEAS} (forming C_{SOLUTION-CORR}) before comparison and selection of best match(es) to the desired shade of the dental restoration.

### Weighted Color Difference

In the present invention, all relevant reflectance/reflectivity curves are converted into chromaticity coordinates (X,Y,Z) from which CIE color coordinates (L,C,H) are generated, as understood by one of ordinary skill in the art. However, to consider small color differences when evaluating dental color differences, an embodiment of the present invention advantageously employs weighting factors or additional elements. The human eye is more sensitive in certain regions of the visible spectrum and the relative brightness (value) of the dental restoration 14 can be a critical component of the shade match. Moreover, the human eye tends to tolerate mismatches that err on being too bright a higher value) than mismatches that err on being too dark (a lower value). By weighting the L component by a predetermined factor F_{L} when a difference between Lsolution and L desired is greater than a threshold ΔLthreshold, the brightness component of shade (L,C,H)ₛₒₗᵤₜᵢₒₙ derived from a reflectance curve Cₛₒₗᵤₜᵢₒₙ may be appropriately considered in a color difference determination ΔE as follows:

ΔL=L_{predicted}−L_{desired}
if ΔL≦ΔLthreshold then L is weighted by weighting factor F_{L} and the weighted color difference formula EQN10 below is used.

ΔEweighted={(F_{L}*ΔL)²+(ΔC)²+(ΔH)²}^{1/2} (EQN 10)

Otherwise, the following unweighted color difference formula EQN12 is used:

ΔEunweighted={(ΔL)²+(ΔC)²+(ΔH)²}^{1/2} (EQN 12)

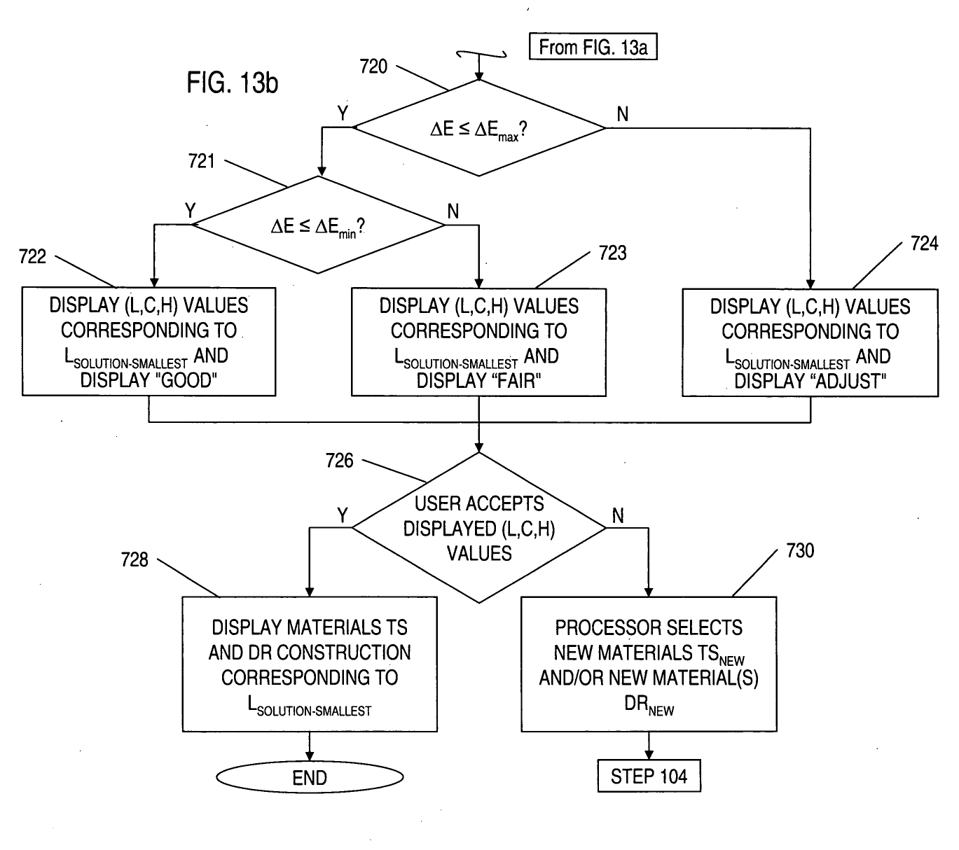

With reference to flow diagram of FIG. 13, an embodiment of a weighted color difference process begins with Step 700 in which a user or the processor sets predetermined weighting factor F_{L}, predetermined threshold ΔL_{threshold}, and predetermined range of acceptable color difference set by ΔE_{Max.} and ΔE_{Min}. In Step 710, each brightness L value of all generated solution reflectance curves Cₛₒₗᵤₜᵢₒₙ is compared to the desired brightness L_{desired} and Query 712 asks if the difference ΔL is within the acceptable range F. For those Lₛₒₗᵤₜᵢₒₙ values that have a ΔL greater than the acceptable range F, Step 714 is employed and the unweighted color difference formula of EQN 12 is applied. For those Lₛₒₗᵤₜᵢₒₙ values that have a ΔL equal to or within the acceptable range F, Step 716 is employed and the weighted color difference formula of EQN 10 is applied. In Step 718, a number N of brightness solutions with a smaller ΔE value are selected. Of those smaller ΔE values selected, they are categorized in Queries 720 and 721 and Steps 722, 723 and 724 as “Good,” “Fair” and “Adjust” depending on whether they are less than or equal to ΔEmax and then ΔEmin. In Query 726, the user can accept or reject the displayed (L,C,H) values. If the values are accepted, the program ends in Step 728. If the values are rejected, Step 730 selects new tooth structure material TS and/or new dental restoration materials(s) DR for a new proposed structuring for the dental restoration, which can continue with Step 104 of FIG. 5 or Step 103 of FIG. 8 or 10, as appropriate or desired.

It is understood by one of ordinary skill in the art that the C and H components of the (L,C,H) values can also be weighted in a similar fashion such that the following weighted color difference formula is used:

ΔEweighted={(F_{L}*ΔL)²+(F_{C}*ΔC)²+(F_{H}*ΔH)²}^{1/2} (EQN 20)

where

F_{C} is the weighting factor for the C component

F_{H} is the weighting factor for the H component

### Display

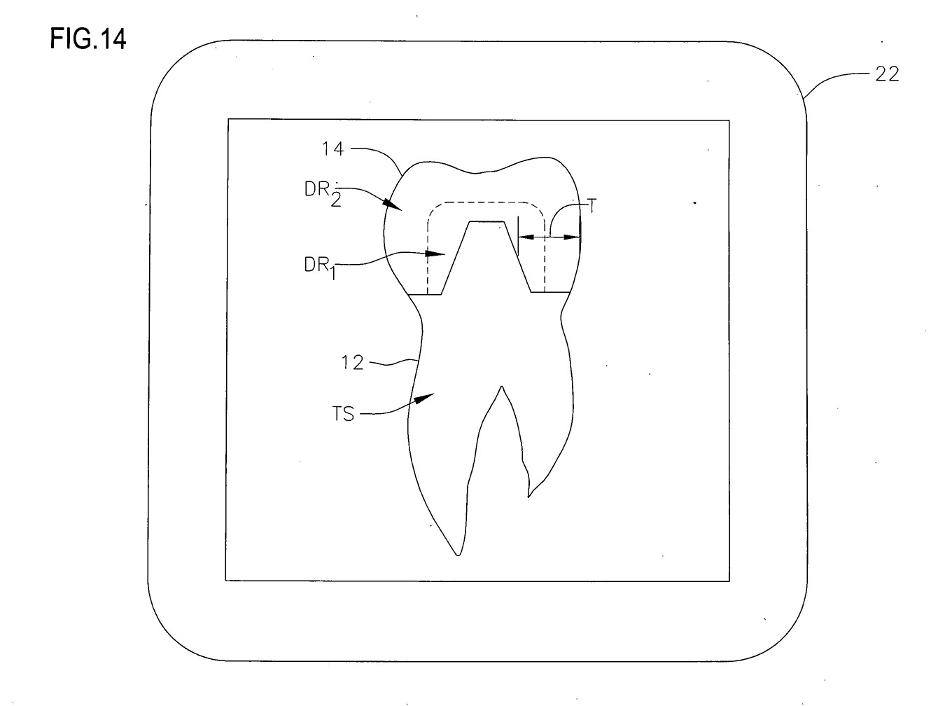

With reference to FIG. 14, in one embodiment, the display 22 of the system S provides a graphical representation of the dental restoration 14 and/or the underlying tooth structure 12. The graphical representation can include identification of the specific tooth structure material TS and dental restorative materials DR used in the selected combination that provided the best shade match. It can also include the thickness T of the target area. Where the method and system of the present invention are adapted to provide a ranking of, for example, the top five best shade match combinations, the display can provide graphical representations of all such five combinations along with the identities of each material used in structuring the combinations.

It is understood by one of ordinary skill in the art, that relevant optical properties may include fluorescence, opalescence, transmittance, reflectance, translucency, hiding potential, luminescence, and/or any derivation of the same. It is also understood that the indices used in identifying and tracking various data values and curves discussed herein are not intended to be exclusive nor limiting on the scope of the present invention. The indices are used merely for the sake of convenience in identifying the various tooth structure and dental restorative materials.

### MISCELLANEOUS

Attached hereto and incorporated herein is an Appendix entitled Reflectance Analysis showing various examples of information, data and operations relating to the present invention.

The preceding description has been presented with reference to presently preferred embodiments of the invention. Workers skilled in the art and technology to which this invention pertains will appreciate that alterations and changes in the described structure may be practiced without meaningfully departing from the principal, spirit and scope of this invention.

Accordingly, the foregoing description should not be read as pertaining only to the precise structures described and illustrated in the accompanying drawings, but rather should be read consistent with and as support to the following claims which are to have their fullest and fair scope.

What is claimed is:

1. A method of determining an optical property of a dental restoration without an opaque layer for an underlying tooth structure, comprising:
storing data representing optical properties of a plurality of different tooth structure materials and a plurality of different translucent dental restorative materials;
providing at least one parameter relating to the underlying tooth structure or the dental restoration;
based on the parameter and a dependency defining resulting optical properties of combinations of one tooth structure material and at least one dental restorative material by treating the tooth structure material as providing a background reflectance for the dental restorative material as a translucent layer applied to the tooth structure material, selecting a combination of one tooth structure material and at least one dental restorative material based on its resulting optical property.

2. A method of claim 1, wherein the optical property relates to reflectance.

3. A method of claim 1, wherein the optical property is reflectance measured in generally equal wavelength intervals between about 320 nm and 700 nm.

4. A method of claim 1, wherein the parameter is one of the following: a thickness measurement of the dental restoration, a desired optical property of the dental restoration, and an optical property of the underlying tooth structure.

5. A method of claim 1, wherein a plurality of parameters are provided, including a thickness measurement of the dental restoration, a desired optical property of the dental restoration, and an optical property of the underlying tooth structure.

6. A method of claim 5, wherein additional parameters include at least one of the following: a number of layers of dental restorative materials in the dental restoration, and a layer ordering of the layers of the dental restorative materials.

7. A method of claim 1, wherein selecting a combination includes selecting a combination providing a best shade match to a parameter of a desired shade of the dental restoration based on converted (L,C,H) values.

8. A method of claim 7, wherein a best shade match is determined by (L,C,H) values converted from reflectance curves.

9. A method of claim 1, wherein the optical property is reflectance measured in generally equal wavelength intervals between about 400 nm and 700 nm.

10. A method of claim 1, wherein the dependency is expressed as:
$${R}_{Solution} = \frac{\frac{{R}_{G}^{TS} - {R}_{inf}^{DR}}{{R}_{inf}^{DR}} - {R}_{inf}^{DR} ( {R}_{G}^{TS} - \frac{1}{{R}_{inf}^{DR}} ) exp [ ST ( \frac{1}{{R}_{inf}^{DR}} - {R}_{inf}^{DR} ) ]}{{R}_{G}^{TS} - {R}_{inf}^{DR} - ( {R}_{G}^{TS} - \frac{1}{{R}_{inf}^{DR}} ) exp [ ST ( \frac{1}{{R}_{inf}^{DR}} - {R}_{inf}^{DR} ) ]}$$
where
Rₛₒₗᵤₜᵢₒₙ=top reflectance of dental restorative material DR with thickness T having a background reflectance R^{TS}_{G} of tooth structure material TS;
R^{DR}_{inf}=measured reflectance of a very thick material DR (a material property called reflectivity)
S=scattering coefficient of material DR and is defined as follows:

11. A method of claim 1, wherein the dependency is applied iteratively such that the combinations are treated as providing a background reflectance for another layer of dental restorative material applied thereto.

12. A method of claim 1, wherein selecting a combination includes selecting a combination of one tooth structure material and at least two different dental restorative materials.

13. A method of claim 1, wherein the dependency treats one tooth structure material and a first layer of dental restorative material as a base layer onto which a second layer of dental restorative material is applied.

14. A method of claim 11, wherein the dependency is expressed as:
$${R}_{Solution}^{DR ( x , y , a , b )} = \frac{\begin{matrix}\frac{{R}_{solution} - {R}_{inf}^{DR ( a , b )}}{{R}_{inf}^{DR ( a , b )}} - {R}_{inf}^{DR ( a , b )} ( {R}_{solution} - \frac{1}{{R}_{inf}^{DR ( a , b )}} ) \\ exp [ ST ( \frac{1}{{R}_{inf}^{DR ( a , b )}} - {R}_{inf}^{DR ( a , b )} ) ]\end{matrix}}{\begin{matrix}{R}_{solution} - {R}_{inf}^{DR ( a , b )} - ( {R}_{Solution} - \frac{1}{{R}_{inf}^{DR ( a , b )}} ) \\ exp [ ST ( \frac{1}{{R}_{inf}^{DR ( a , b )}} - {R}_{inf}^{DR ( a , b )} ) ]\end{matrix}}$$
where
R^{DR(x,y,a,b)}ₛₒₗᵤₜᵢₒₙ is a top reflectance of the another layer of dental restorative material DR(a,b) that results from treating the combination of tooth structure material TS and dental restorative material DR(x,y) as providing a background reflectance therefor,
T is a thickness of the layer of dental restorative material DR(a,b), and
R^{DR(a,b)}_{inf} is measured reflectance of a very thick layer of dental restorative material DR(a,b).

15. A method of claim 1, wherein the data of optical properties of different tooth structure materials are derived from shade systems.

16. A method of claim 1, wherein the data of optical properties of different tooth structure materials are derived from measurements of a representative of sample n of human teeth, wherein n is greater than about 100.

17. A method of claim 1, wherein the dental restorative materials have optical properties that are dependent on thickness of the materials.

18. A method of claim 1, wherein the optical property is one of the following: fluorescence, opalescence, transmittance, reflectance, translucency, hiding potential, luminescence, and/or any derivation of thereof.

19. A method of claim 4, wherein the thickness measurement is determined by measurement of a wax pattern.

20. A method of claim 4, wherein the thickness measurement is determined through digital measurement of a virtual restoration.

21. A method of claim 4, wherein the thickness measurement is an average thickness measurement of a region of the dental restoration selected by a user.

22. A method of providing a database of optical properties of a plurality of different tooth structure materials and a plurality of different translucent dental restorative materials for use in constructing a dental restoration for an underlying tooth structure, comprising:
providing reflectance values for each tooth structure material and each dental restorative material;
applying a dependency to determine resulting reflectance values for each combination of a different tooth structure material and at least one different dental tooth restorative material, by treating reflectance values of each tooth structure material as reflectance of a background to which at least one layer of a different dental restorative material is applied; and

23. A method of claim 22, further comprising storing the resulting reflectance values.

24. A method of claim 22, further comprising converting the resulting reflectance values to (L,C,H) values.

25. A method of claim 22, further comprising converting the resulting reflectance values to (L,C,H) values and storing same.

26. A method of claim 22, wherein providing reflectance values includes correcting measured reflectance values to account for manner by which reflectance values are measured.

27. A method of claim 23, further comprising weighting at least one of the (L,C,H) values.

28. A system of generating a graphical representation of a dental restoration for an underlying tooth structure, comprising:
a database storing data representing optical properties of a plurality of tooth structure materials and a plurality of dental restorative materials;
an input member to receive at least one parameter relating to the dental restoration or the underlying tooth structure;
a processor configured to select a combination of one tooth structure material representing the underlying tooth structure and at least one dental restorative material representing the dental restoration based on the one parameter and a dependency between the tooth structure materials and the dental restorative materials that treats the tooth structure materials as a base layer onto which at least one layer of dental restorative materials is applied; and
a display adapted to display a visual representation of the selected combination.
